(19) United States
(12) Patent Application Publication
(10) Pub. No.: US 2021/0216411 A1
(43) Pub. Date: Jul. 15, 2021

(54) CLUSTER BACKUP MANAGEMENT

(71) Applicant: salesforce.com, inc., San Francisco, CA (US)

(72) Inventors: Karthik Mohan SUBRAMANIAN, Sunnyvale, CA (US); Ted LIU, Los Altos, CA (US); Yeshwant Sai MADANAGOPAL, Fremont, CA (US); Youngjin YU, Cupertino, CA (US)

(21) Appl. No.: 16/738,575

(22) Filed: Jan. 9, 2020

(51) Int. Cl. G06F 11/14; G06F 11/30; G06F 16/182

(52) U.S. Cl. CPC G06F 11/1464; G06F 11/1461; G06F 16/183; G06F 11/1451; G06F 11/3034; G06F 11/1469

(57) ABSTRACT

In a cloud computing environment, a cluster backup management system of a database storage system directly determines which nodes in the cluster are suitable for use in backup operations without relying on a static configuration. The system automates sampling of the status of each node in a storage cluster and evaluating the health of a node to determine whether it is eligible to support a backup operation. A backup job scheduling and execution process uses the sampled status and health evaluations to automatically determine which nodes are eligible to use for backup operations.

### TECHNICAL FIELD

Embodiments of the invention relate generally to the field of computer data storage, and more particularly, to managing data storage backups.

### BACKGROUND

Modern software for enterprise computing is often provided as a service in a scalable, on-demand cloud computing environment, commonly referred to as software as a service (SaaS) hosted on a platform as a service (PaaS).

The PaaS is typically provided using cloud computing. Cloud computing is an information technology paradigm for enabling ubiquitous access to shared pools of configurable resources (such as computer networks, servers, data storage, applications and services). The configurable resources are designed to be rapidly provisioned with minimal management effort, often over the Internet. Cloud computing allows users and enterprises with various computing capabilities to store and process data either in a privately-owned cloud, or on third-party servers located in data centers, thus making data-accessing mechanisms more efficient and reliable.

The servers and other data storage resources of cloud computing often store distributed databases. A distributed database can be an organized collection of information that is dispersed over a network of interconnected computers, which may be referred to as a cluster of nodes, such as a cloud computing network. A high availability distributed database system provides continued access to data in a database even after a failure of a node prevents an end user from accessing a stored copy of the database. For example, if each of three nodes store a copy (or replica) of a database, after the failure of one node the end user can still access the data in the database through one of the other available nodes that stores a replica of the database.

From time to time, in order to insure continuous high availability of a database, a PaaS provider typically performs a backup of the cluster of nodes among other data protection measures. Since not all nodes may be fully operational at the time of the backup, the backup jobs can fail, or the databases can be backed up on nodes that are not healthy and prone to later failure.

### BRIEF DESCRIPTION OF THE DRAWINGS

The included drawings, by way of example only and not limitation, illustrate possible structures and operations for implementing the disclosed inventive systems, apparatus, methods, and computer-readable storage media. The drawings do not limit any changes in form and detail that may be made by one skilled in the art consistent with the spirit and scope of the disclosed implementations.

FIG. 1 is a block diagram overview of a system for cluster backup management in a cloud computing platform according to one embodiment;

FIG. 2 is a block diagram of additional details of a cluster backup management system in a cloud computing platform according to one embodiment;

FIGS. 3-6 are flow diagrams of processes for a cluster backup management system in a cloud computing platform according to one embodiment;

FIGS. 7A-7B are block diagrams illustrating an overview of a cloud computing environment within which one or more implementations of a cluster backup management system can be carried out; and

FIG. 8 is a block diagram illustrating a machine in the exemplary form of a general computer system within which one or more implementations of a cluster backup management system can be carried out.

### DETAILED DESCRIPTION

Current database cluster backup automation methods rely on a static configuration that tell the automation software which nodes in a cluster to use during a backup. If current states of some of the nodes in the database cluster are not suitable for use for backup purposes, then the backup operation on that database cluster may not execute successfully. Manual intervention is required to update the static configuration to tell the software which nodes to exclude. For example, a script for a backup automation job would need to be modified to exclude a failed node, copied to a secondary node and triggered to execute from the secondary node.

To address this challenge, a cluster backup management system includes processes to determine directly which nodes in a cluster are eligible for use in a backup operation without relying the cluster's static configuration. The reliance on the static configuration for backup purposes can be eliminated or at least reduced.

In one embodiment, a cluster backup management system includes an automatic sampling of the state of each node within a database cluster. In addition, the cluster backup management system includes an assessment of each node's eligibility for supporting a backup operation. The cluster backup management system further includes backup job scheduling and execution processes to dynamically determine which nodes are eligible to use for backup purposes, and to schedule and execute the backup job on the eligible nodes without further intervention, manual or otherwise.

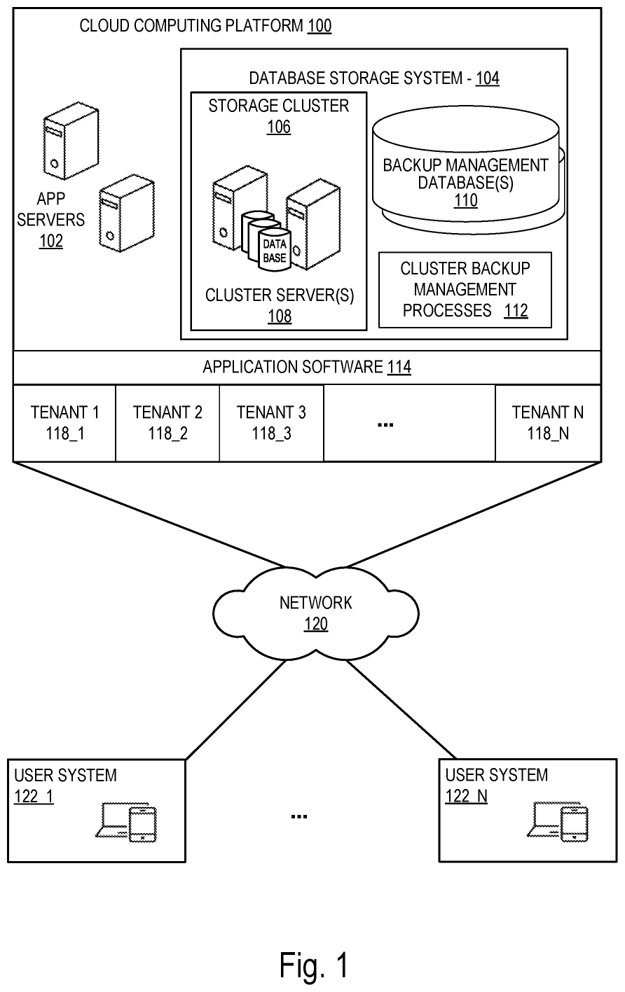

FIG. 1 illustrates an example cloud computing platform 100 in which embodiments of a cluster backup management system can be implemented. Cloud computing platform 100 can include various application servers 102 and a database storage system 104 for providing a data storage PaaS. The database storage system 104 includes storage cluster(s) 106 comprising cluster server(s) 108, also referred to herein as storage nodes, to support databases, all of which are connected via a network 120. During operation of cloud computing platform 100, different combinations of application servers 102, storage clusters 106, and cluster server(s) 108 can execute various types of application software 110 and access one or more databases stored in one or more of the cluster's servers 108.

In one embodiment, the database storage system 104 implements the cluster backup management system using special purpose repositories for storing backup management data, such as backup management databases 110. The database storage system 104 further includes several cluster backup management processes 112 that contain the logic for implementing the cluster backup management system.

User systems 122_1 to 122_N typically connect to application servers 102, data server 104 and databases 106 through a network 120. Network 120 includes internal networks (not shown), local area networks (LANs), wide area networks (WANs), privately or publicly switched telephone networks (PSTNs), wireless (Wi-Fi) networks, cellular or mobile telecommunications networks, and any other similar networks, or any combination thereof. Cloud computing platform 100 and user systems 122_1 to 122_N can operate within a private enterprise network, within a publicly accessible web-based network, such as via the Internet, or within any combination of networks.

User systems 122_1 to 122_N can include personal computers (PCs), including workstations, laptop or notebook computers, tablet computers, handheld computing devices, cellular or mobile phones, smartphones, terminals, or any other device capable of accessing network 120 and cloud computing platform 100. User systems 122_1 to 122_N can use different protocols to communicate with cloud computing platform 100 over network 120, such as Transmission Control Protocol and Internet Protocol (TCP/IP), Hypertext Transfer Protocol (HTTP), and/or File Transfer Protocol (FTP), to name a few non-limiting examples. In one example, user systems 122_1 to 122_N can operate web browsers or applications that can send and receive HTTP messages to and from an HTTP server operating in cloud computing platform 100.

Cloud computing platform 100 in conjunction with application software 110 and database storage system 104 can provide an almost limitless variety of different services to support different types of business enterprise needs. For example, the aforementioned SaaS and PaaS services to support various business enterprise applications, such as customer relationship management (CRM), enterprise resource planning (ERP), file sharing, web-based commerce or e-commerce, social networking, cloud-based computing and/or storage, any other similar service, or any combination thereof. Cloud computing platform 100 and/or network 120 can be alternatively referred to as a cluster, cloud, and/or cloud-based computing system.

In one embodiment, application software 110 can interoperate with a third-party vendor of a database storage system 104, such as Amazon Web Services, Google Cloud Service and Microsoft Azure Cloud, to support different types of business enterprise needs. The database storage system 104 is typically operated on one or more networked physical data centers that provide the data storage hardware infrastructure. The vendors of the data storage hardware infrastructure can vary from one data center to another.

In one example, cloud computing platform 100, application software 110 and database storage system 104 can operate as a multi-tenant system (MTS). A multi-tenant system refers to a database system where different hardware and software can be shared by one or more organizations represented as tenants (118_1, 118_2, 118_3, . . . 118_N; collectively “tenants 118”). For example, cloud computing platform 100 can associate a first tenant 118_1 with an organization that sells airline services, associate a second tenant 118_2 with an organization that sells widgets, and associate a third tenant 118_3 with an organization that sells medical administration services. The multi-tenant system can effectively operate as multiple virtual databases each associated with one of tenants 118.

In one embodiment, the application servers 102 and storage clusters 106 can be organized into pods (not shown) that include groups of application servers 102, cluster servers 108 and associated databases that share an instance of the multi-tenant system. Different pods can operate independently but can share some processing and infrastructure equipment, such as routers (not shown) and storage area networks (SANs) (not shown). For example, tenants 118_2 and 118_3 can operate within one pod and a user associated with tenant 118_3 can use user system 122_1 to access the multi-tenant system operating in a same or different pod.

In one embodiment, user system 122_1 can send requests from the user to a load balancer (not shown). In response, the load balancer can forward the requests to one of the application servers 102. Application server 102 can service the requests by executing application software 110, including processing requests that involve transactions through third-party application software and/or accessing data servers 104 serving data from cluster servers 108 within a storage cluster 106 or from elsewhere as needed.

Cloud computing platform 100 can include, for example, hundreds of storage clusters 106, and a database administrator can assign thousands of tenants 118 to a shared storage cluster. A database administrator can add or modify storage clusters 106 for servicing additional tenants 118 and/or can reassign any of tenants 118 to different storage clusters within the database storage system 104. For example, one of tenants 118 can use a relatively large amount of processing bandwidth and/or use a relatively large amount of storage space. The database administrator can reassign that tenant, e.g., 118_2, to a storage cluster 106 with more processing bandwidth and/or storage capacity than the originally assigned cluster. Thus, the multi-tenant system can scale for practically any number of tenants and users.

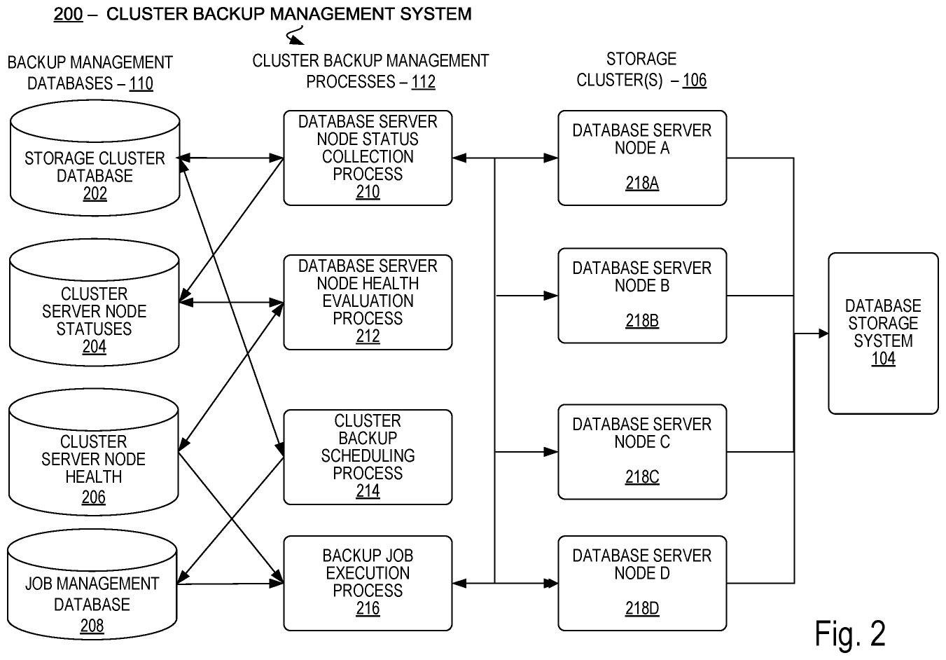

FIG. 2 illustrates additional details of an embodiment of a cluster backup management system 200 as might be implemented in the cloud computing environment 100 described in FIG. 1. In one embodiment, the cluster backup management system 200 includes the database storage system 104 comprising backup management databases 110, cluster backup management processes 112 and storage clusters 106. The backup management databases 110 function as repositories for a storage cluster database 202 to identify and track the storage clusters 106, a cluster server node statuses repository in which to collect one or more cluster server node statuses periodically sampled from the cluster servers 108 and a cluster server node health database 206 to store a current health of a cluster server node in the cluster servers 108. Lastly, the backup management databases 110 include a job management database 208 in which to store data for automatically scheduling and executing a backup job based on the current health of the cluster server nodes as stored in the cluster server node health database 206. In one embodiment, the backup management databases 110 can instead or in addition include tables or other data structures for storing and accessing the information for supporting the cluster backup management system 200.

In one embodiment, the cluster backup management system 200 includes several cluster backup management processes 112, including a database server node status collection process 210 to sample and collect various status information about each node, a database server node health evaluation process 212 to evaluate the health of each node based on the collected status data, and a cluster backup scheduling process 214 and a backup job execution process 216 to schedule and execute backup jobs to back up one or more cluster server nodes 108 of a storage cluster 106.

In one embodiment, the backup management databases 110 and cluster backup management processes 112 interoperate to automate the backup jobs to back up the one or more cluster server nodes 108 that comprise the storage clusters 106 tracked in the backup management databases 110, such as a database server nodes A, 218A, node B, 218B, node C 218 C and node D, 218D. In one embodiment, an application server 102 manages the storage clusters 106 in communication with any of the backup management databases 110 and cluster backup management processes 112.

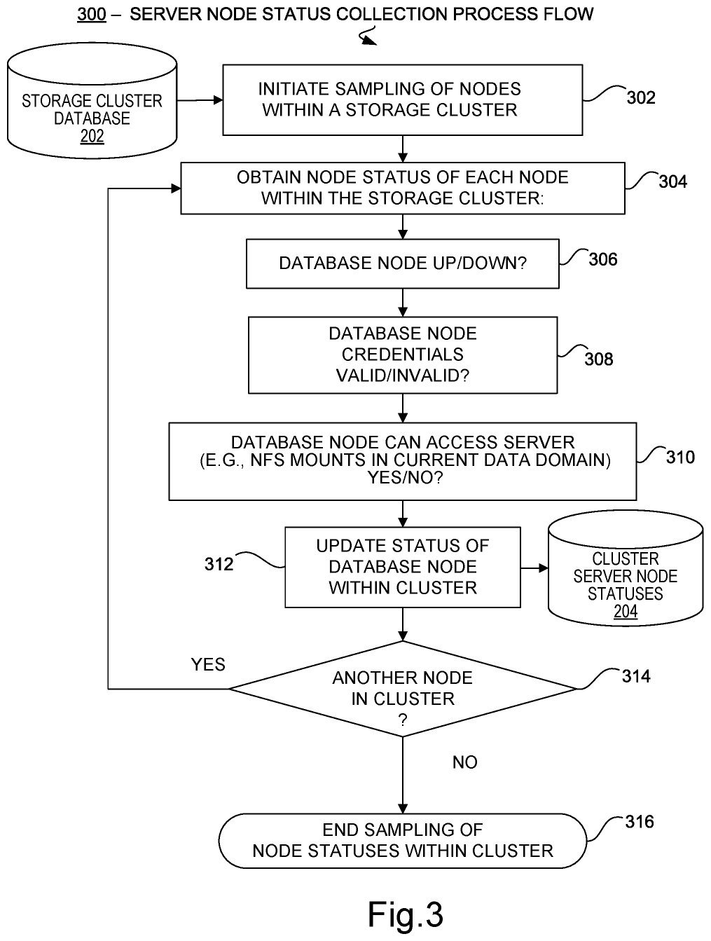

FIG. 3 illustrates a flow diagram for an embodiment of a server node status collection process 300 for a cluster backup management system 200 in a cloud computing platform 100 according to one embodiment. The process 300 begins at 302 by initiating a sampling of nodes within a storage cluster. The sampling can be initiated on demand or periodically in accordance with a data protection policy implemented for the database storage system 104. At 302, the process 300 obtains a node status of each node within the storage cluster, where each node is identified in the storage cluster database 202. In one embodiment, the identifier of the cluster of storage nodes is based on a network identifier defined for the cluster in a network of storage nodes organized into clusters.

The node status can include information about the node, such as whether the node in the storage cluster is operational (up) or non-operational (down) as determined at 306. The node status can also include information about whether the credentials for accessing the node by a backup job are valid or invalid, as determined at 308. As illustrated at 310, another example of node status information is whether the node can access the server(s), for example whether the NFS (Network File System) mounts are in the current data protection domain (valid or invalid mount status) and accessible by the backup job (valid or invalid credentials).

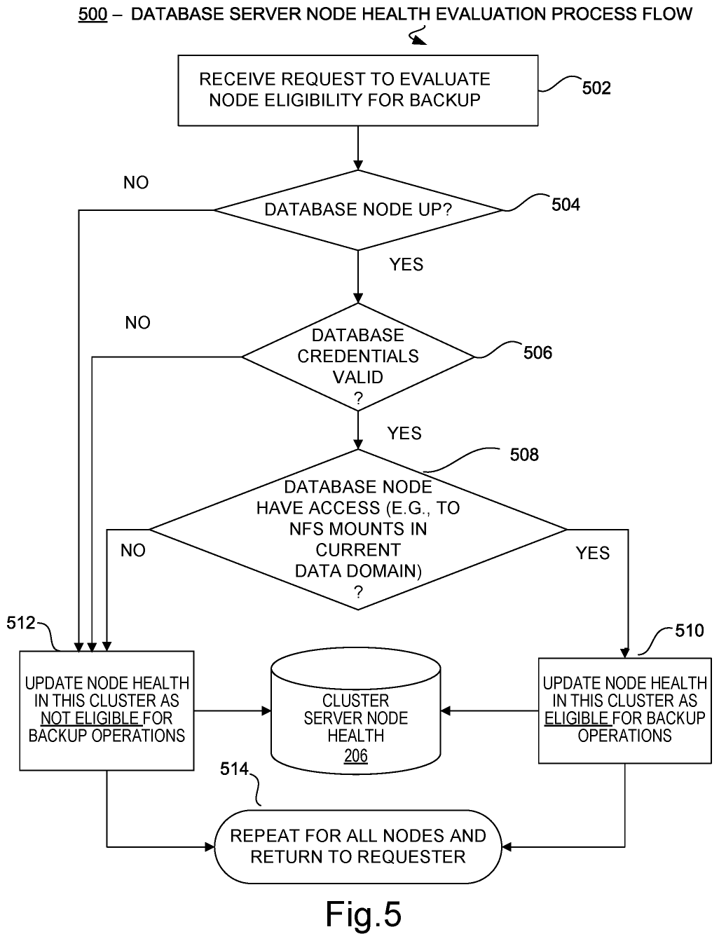

In one embodiment, once the node's status information has been collected, the process 312 updates the cluster server node statuses repository 204. At decision block 314, the process 300 continues if there is another node in the cluster. Once the status information for all of the nodes within the cluster has been collected, the process 300 concludes at 316 and ends the sampling of node statuses within the cluster. At the conclusion of the process 300, the cluster server node statuses repository 204 should be completely populated in preparation for determining the health of each of the nodes as will be described further with reference to FIG. 5.

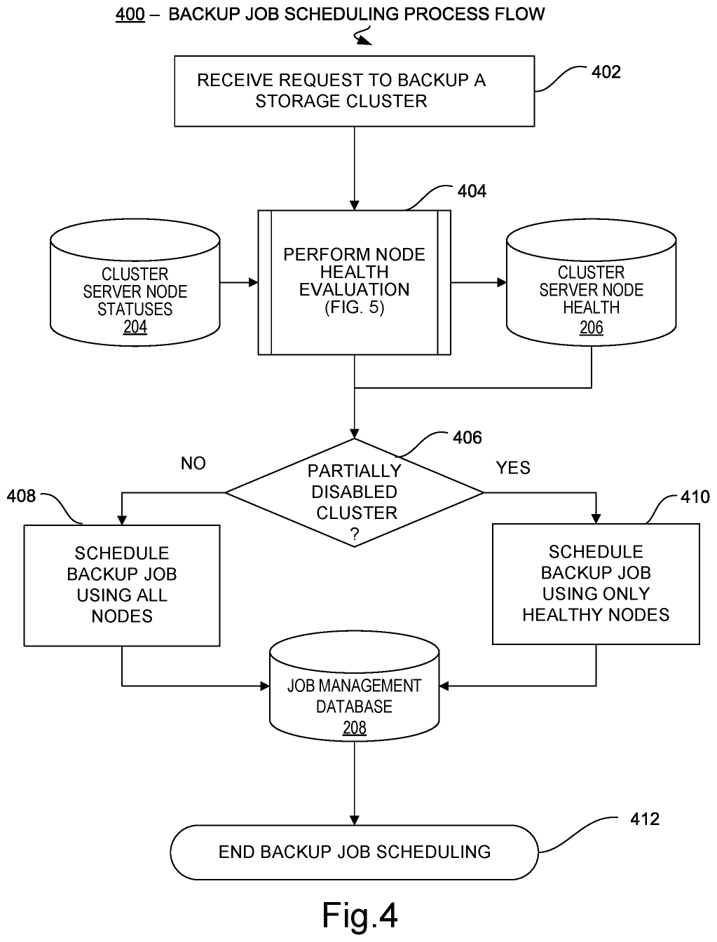

FIG. 4 illustrates a flow diagram for an embodiment of a backup job scheduling process 400 for a cluster backup management system 200 in a cloud computing platform 100 according to one embodiment. At 402, the process 400 receives a request to back up a storage cluster. Using the cluster server node statuses repository 204 (as populated during the collection process described in FIG. 3), the process 400 invokes a subprocess 404 to perform a node health evaluation for each of the nodes in the storage cluster. In one embodiment, evaluating the node health status is based on a current operation status of the storage node in the cluster, including any of how recently the storage node executed a backup operation, whether the storage node NFS mount status is valid and whether the storage node has a valid credential for the executing the backup job for the cluster. The cluster server node health repository 206 receives the results of the node health evaluation. At decision block 406, the process 400 determines whether the storage cluster is a partially disabled cluster. If not, then at 408, the process 400 schedules the backup job using all of the nodes of the storage cluster. However, if the storage cluster is partially disabled, then at 410, the process 400 schedules the backup job using only the healthy nodes of the storage cluster. In either case, the process 400 concludes at 412 by storing the scheduled backup job information in the job management database 208. Scheduling the backup job can include generating a backup action request for the identifier of the cluster in a job management table of the job management database 208.

FIG. 5 illustrates a flow diagram for an embodiment of a node health evaluation process 500 for a cluster backup management system 200 in a cloud computing platform 100 according to one embodiment. At 502, the process 500 receives a request to evaluate node eligibility for backup. In one embodiment, the request is triggered at 404 of the backup job scheduling process 400 in response to the request to back up a storage cluster (FIG. 4). At decision block 504 the process 500 evaluates node eligibility for backup by checking current operational status information collected for the node (as described in FIG. 3). In one embodiment, the node being evaluated is considered eligible if the node is operational (up) 504, if the credentials to access the database at the node are valid 506, and if the node has sufficient access, e.g., whether the node has access to NFS mounts in the current data domain 508. If all of the evaluations are satisfied, then at 510, the process 500 updates the cluster server node health 206 in the cluster as eligible for backup operations. Otherwise, at 512, the process 500 updates the cluster server node health 206 in the cluster as not eligible for backup operations. At 514, the process 500 is repeated for all nodes in the storage cluster, and then control is returned to the requester, in this case the process 400 at 404.

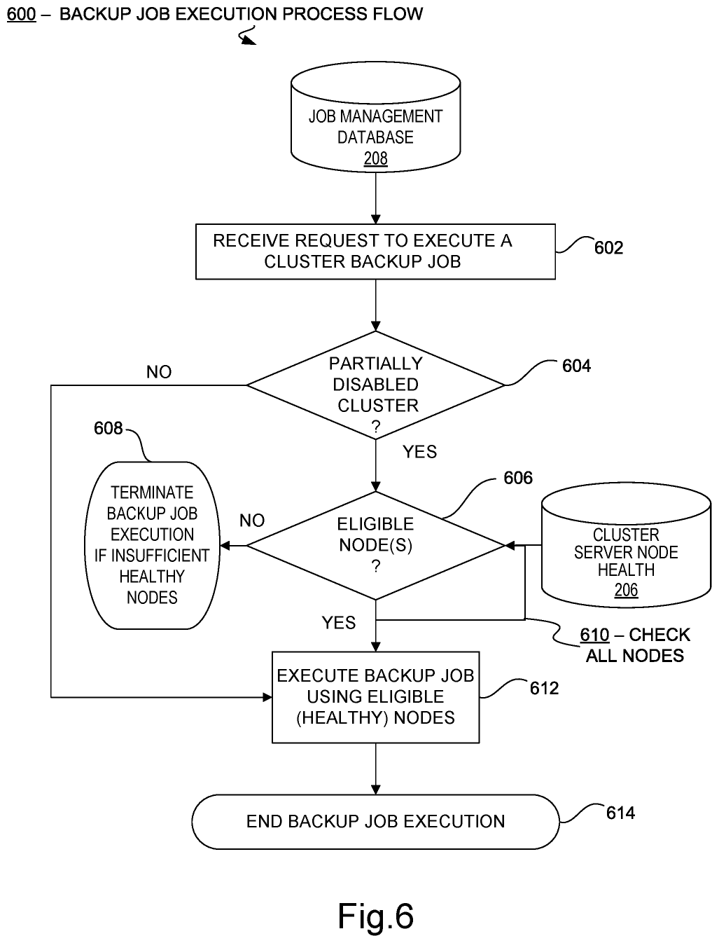

FIG. 6 illustrates a flow diagram for an embodiment of a backup job execution process 600 for a cluster backup management system 200 in a cloud computing platform 100 according to one embodiment. At 602, the process receives a backup action request to execute a cluster backup job. In one embodiment, the backup action request is obtained by periodically polling the job management database 208 for the backup job, including polling the job management database for new backup action requests. Using the job management database 208 in which the scheduled backup job information has been stored as part of process 400 at 412 (FIG. 4), the process 600, at decision block 604, determines whether the storage cluster scheduled for backup is a partially disabled cluster. If not, then at 612 the process 600 executes the backup jobs using all nodes since all nodes are eligible when the cluster is not partially disabled.

In one embodiment, if the cluster is determined to be partially disabled, then using the cluster server node health repository 206, the process 600 continues at 606 to determine which nodes are eligible for backup operations, repeating 610 the determination 606 until all nodes have been checked. If none (or, if too few) are eligible, then at block 608 the process 600 terminates the backup job execution since there are insufficient healthy nodes. However, if there are a sufficient number of eligible (healthy) nodes for the cluster, then at 612 the process 600 executes the backup jobs using only those eligible nodes. At 614, the process 600 terminates and the backup job execution is completed.

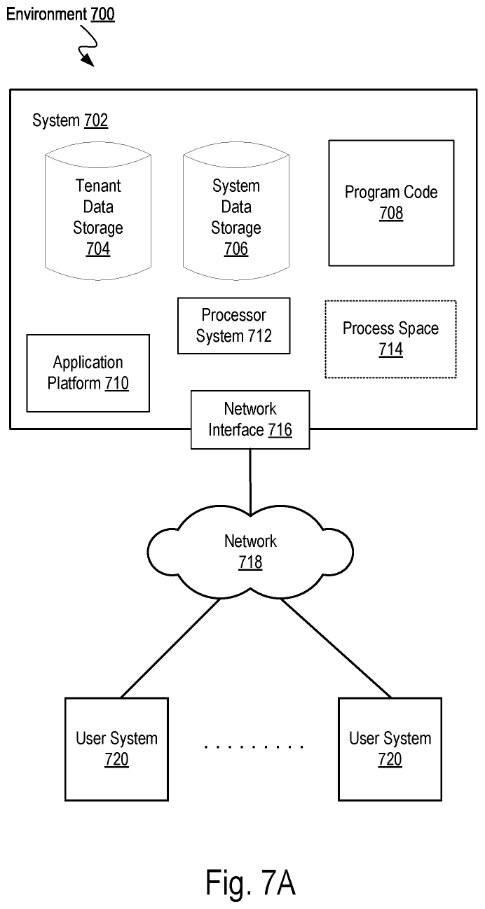

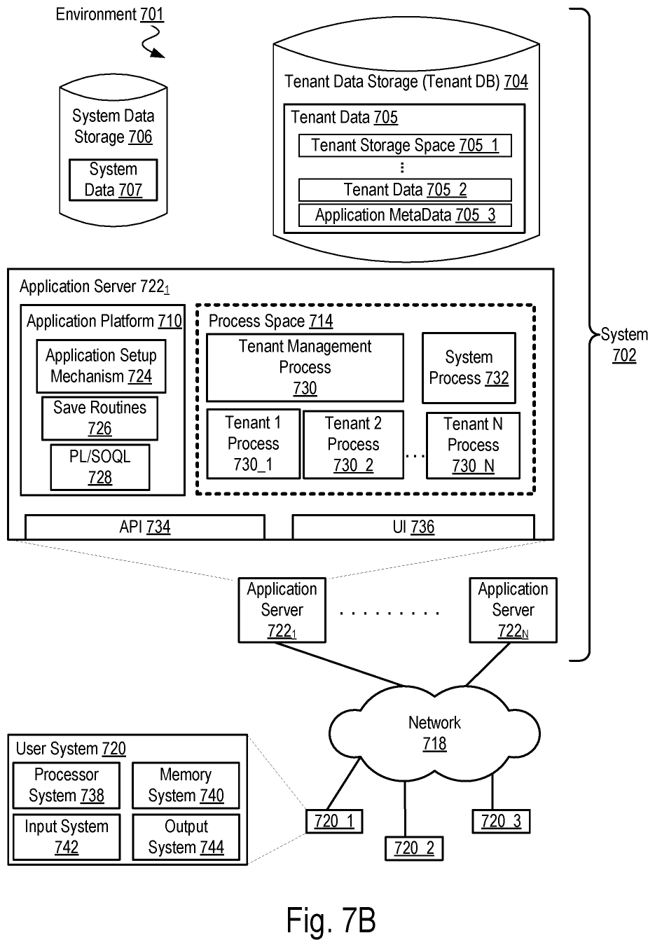

FIG. 7A illustrates a block diagram of an environment 700 in which an on-demand database service supported with a cluster backup management system 200 can be implemented in accordance with the described embodiments. Environment 700 may include user systems 720, network 718, system 702, processor system 712, application platform 710, network interface 716, tenant data storage 704, system data storage 706, program code 708, and process space 714. In other embodiments, environment 700 may not have all the components listed and/or may have other elements instead of, or in addition to, those listed above.

Environment 700 is an environment in which an on-demand database service exists. User system 720 may be any machine or system that is used by a user to access a database user system. For example, any of user systems 720 can be a handheld computing device, a mobile phone, a laptop computer, a workstation, and/or a network of computing devices. As illustrated in FIG. 7A (and in more detail in FIG. 7B) user systems 720 might interact via a network 718 with an on-demand database service, which is system 702.

An on-demand database service, such as system 702, is a database system that is made available as a PaaS to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 702” and “system 702” is used interchangeably herein. A database image may include one or more database objects. A relational database management system (RDMS) or the equivalent may execute storage and retrieval of information against the database object(s). Application platform 710 may be a framework that allows the applications of system 702 to run, such as the hardware and/or software, e.g., the operating system. In an embodiment, on-demand database service 702 may include an application platform 710 that enables creation, managing and executing one or more applications developed by the provider of the on-demand database service, users accessing the on-demand database service via user systems 720, or third party application developers accessing the on-demand database service via user systems 720.

The users of user systems 720 may differ in their respective capacities, and the capacity of a user system 720 might be entirely determined by permissions (permission levels) for the current user. For example, where a salesperson is using a user system 720 to interact with system 702, that user system has the capacities allotted to that salesperson. However, while an administrator is using that user system to interact with system 702, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 718 is any network or combination of networks of devices that communicate with one another. For example, network 718 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it is understood that the networks that the claimed embodiments may utilize are not so limited, although TCP/IP is a frequently implemented protocol.

User systems 720 might communicate with system 702 using TCP/IP and, at a higher network level, use other common Internet protocols to communicate, such as HTTP, FTP, AFS, WAP, etc. In an example where HTTP is used, user system 720 might include an HTTP client commonly referred to as a “browser” for sending and receiving HTTP messages to and from an HTTP server at system 702. Such an HTTP server might be implemented as the sole network interface between system 702 and network 718, but other techniques might be used as well or instead. In some implementations, the interface between system 702 and network 718 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In one embodiment, system 702, shown in FIG. 7A, implements a web-based customer relationship management (CRM) system. For example, in one embodiment, system 702 includes application servers configured to implement and execute CRM software applications as well as provide related data, code, forms, webpages and other information to and from user systems 720 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 702 implements applications other than, or in addition to, a CRM application. For example, system 702 may provide tenant access to multiple hosted (standard and custom) applications, including a CRM application. User (or third-party developer) applications, which may or may not include CRM, may be supported by the application platform 710, which manages creation, storage of the applications into one or more database objects and executing of the applications in a virtual machine in the process space of the system 702.

One arrangement for elements of system 702 is shown in FIG. 7A, including a network interface 716, application platform 710, tenant data storage 704 for tenant data 705, system data storage 706 for system data 707 accessible to system 702 and possibly multiple tenants, program code 708 for implementing various functions of system 702, and a process space 714 for executing MTS system processes and tenant-specific processes, such as running applications as part of an application hosting service. Additional processes that may execute on system 702 include database indexing processes.

Several elements in the system shown in FIG. 7A include conventional, well-known elements that are explained only briefly here. For example, each user system 720 may include a desktop personal computer, workstation, laptop, PDA, cell phone, or any wireless access protocol (WAP) enabled device or any other computing device capable of interfacing directly or indirectly to the Internet or other network connection. User system 720 typically runs an HTTP client, e.g., a browsing program, such as Microsoft's Internet Explorer browser, a Mozilla or Firefox browser, an Opera, or a WAP-enabled browser in the case of a smartphone, tablet, PDA or other wireless device, or the like, allowing a user (e.g., subscriber of the multi-tenant database system) of user system 720 to access, process and view information, pages and applications available to it from system 702 over network 718. Each user system 720 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by system 702 or other systems or servers. For example, the user interface device can be used to access data and applications hosted by system 702, and to perform searches on stored data, and otherwise allow a user to interact with various GUI pages that may be presented to a user. As discussed above, embodiments are suitable for use with the Internet, which refers to a specific global internetwork of networks. However, it is understood that other networks can be used instead of the Internet, such as an intranet, an extranet, a virtual private network (VPN), a non-TCP/IP based network, any LAN or WAN or the like.

According to one embodiment, each user system 720 and all its components are operator configurable using applications, such as a browser, including computer code run using a central processing unit such as an Intel Pentium® processor or the like. Similarly, system 702 (and additional instances of an MTS, where more than one is present) and all of their components might be operator configurable using application(s) including computer code to run using a central processing unit such as processor system 712, which may include an Intel Pentium® processor or the like, and/or multiple processor units.

According to one embodiment, each system 702 is configured to provide webpages, forms, applications, data and media content to user (client) systems 720 to support the access by user systems 720 as tenants of system 702. As such, system 702 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS may include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It is understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 7B illustrates another block diagram of an embodiment of elements of FIG. 7A and various possible interconnections between such elements in accordance with the described embodiments. FIG. 7B also illustrates environment 701. However, in FIG. 7B, the elements of system 702 and various interconnections in an embodiment are illustrated in further detail. More particularly, FIG. 7B shows that user system 720 may include a processor system 738, memory system 740, input system 742, and output system 744. FIG. 7B shows network 718 and system 702. FIG. 7B also shows that system 702 may include tenant data storage 704, having therein tenant data 705, which includes, for example, tenant storage space 705_1, tenant data 705_2, and application metadata 705_3. System data storage 706 is depicted as having therein system data 707. Further depicted within the expanded detail of application servers 722_{1-N} are User Interface (UI) 736, Application Program Interface (API) 734, application platform 710 includes PL/SOQL 728, save routines 726, application setup mechanism 724, process space 714 includes system process space 732, tenant 1-N process spaces 730_1, and tenant management process space 730. In other embodiments, environment 701 may not have the same elements as those listed above and/or may have other elements instead of, or in addition to, those listed above.

User system 720, network 718, system 702, tenant data storage 704, and system data storage 706 were discussed above in FIG. 7A. As shown by FIG. 7B, system 702 may include a network interface 716 (of FIG. 7A) implemented as a set of HTTP application servers 722, an application platform 710, tenant data storage 704, and system data storage 706. Also shown is system process space 732, including individual tenant process spaces 730_1 and a tenant management process space 730. Each application server 722 may be configured to tenant data storage 704 and the tenant data 705 therein, and system data storage 706 and the system data 707 therein to serve requests of user systems 720. The tenant data 705 might be divided into individual tenant storage areas (e.g., tenant storage space 705_1), which can be either a physical arrangement and/or a logical arrangement of data. Within each tenant storage space 705_1, tenant data 705_2, and application metadata 705_3 might be similarly allocated for each user. For example, a copy of a user's most recently used (MRU) items might be stored to tenant data 705_2. Similarly, a copy of MRU items for an entire organization that is a tenant might be stored to tenant storage space 705_1. A UI 736 provides a user interface and an API 734 provides an application programmer interface into system 702 resident processes to users and/or developers at user systems 720. The tenant data and the system data may be stored in various databases, such as one or more Oracle™ databases.

Application platform 710 includes an application setup mechanism 724 that supports application developers' creation and management of applications, which may be saved as metadata into tenant data storage 704 by save routines 726 for execution by subscribers as one or more tenant process spaces 730_1 managed by tenant management process space 730 for example. Invocations to such applications may be coded using PL/SOQL 728 that provides a programming language style interface extension to API 734. Invocations to applications may be detected by one or more system processes, which manage retrieving application metadata 705_3 for the subscriber making the invocation and executing the metadata as an application in a virtual machine.

Each application server 722 may be communicably coupled to database systems, e.g., having access to system data 707 and tenant data 705, via a different network connection. For example, one application server 722₁ might be coupled via the network 718 (e.g., the Internet), another application server 722_{N-1} might be coupled via a direct network link, and another application server 722_{N} might be coupled by yet a different network connection. Transfer Control Protocol and Internet Protocol (TCP/IP) are typical protocols for communicating between application servers 722 and the database system. However, it will be apparent to one skilled in the art that other transport protocols may be used to optimize the system depending on the network interconnect used.

In certain embodiments, each application server 722 is configured to handle requests for any user associated with any organization that is a tenant. Because it is desirable to be able to add and remove application servers from the server pool at any time for any reason, there is preferably no server affinity for a user and/or organization to a specific application server 722. In one embodiment, therefore, an interface system implementing a load balancing function (e.g., an F5 Big-IP load balancer) is communicably coupled between the application servers 722 and the user systems 720 to distribute requests to the application servers 722. In one embodiment, the load balancer uses a least connections algorithm to route user requests to the application servers 722. Other examples of load balancing algorithms, such as round robin and observed response time, also can be used. For example, in certain embodiments, three consecutive requests from the same user may hit three different application servers 722, and three requests from different users may hit the same application server 722. In this manner, system 702 is multi-tenant, in which system 702 handles storage of, and access to, different objects, data and applications across disparate users and organizations.

As an example of storage, one tenant might be a company that employs a sales force where each salesperson uses system 702 to manage their sales process. Thus, a user might maintain contact data, leads data, customer follow-up data, performance data, goals and progress data, etc., all applicable to that user's personal sales process (e.g., in tenant data storage 704). In an example of an MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 702 that are allocated at the tenant level while other data structures might be managed at the user level. Because an MTS might support multiple tenants including possible competitors, the MTS may have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 702 might also maintain system level data usable by multiple tenants or other data. Such system level data might include industry reports, news, postings, and the like that are sharable among tenants.

In certain embodiments, user systems 720 (which may be client systems) communicate with application servers 722 to request and update system-level and tenant-level data from system 702 that may require sending one or more queries to tenant data storage 704 and/or system data storage 706. System 702 (e.g., an application server 722 in system 702) automatically generates one or more SQL statements (e.g., one or more SQL queries) that are designed to access the desired information. System data storage 706 may generate query plans to access the requested data from the database.

Each database can generally be viewed as a collection of objects, such as a set of logical tables, containing data fitted into predefined categories. A “table” is one representation of a data object and may be used herein to simplify the conceptual description of objects and custom objects as described herein. It is understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It is understood that the word “entity” may also be used interchangeably herein with “object” and “table.”

In some multi-tenant database systems, tenants may be allowed to create and store custom objects, or they may be allowed to customize standard entities or objects, for example by creating custom fields for standard objects, including custom index fields. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

The term “user” may refer to a system user, such as, but not limited to, a software/application developer, a system administrator, a database administrator, an information technology professional, a program manager, product manager, etc. The term “user” may also refer to an end-user, such as, but not limited to, an organization (e.g., a business, a company, a corporation, a non-profit entity, an institution, an agency, etc.) serving as a customer or client of the provider (e.g., Salesforce.com®) of a user device (such as user device 180 in FIG. 1) or an organization's representative, such as a salesperson, a sales manager, a product manager, an accountant, a director, an owner, a president, a system administrator, a computer programmer, an information technology (“IT”) representative, etc.

It is to be noted that any references to software codes, data and/or metadata (e.g., Customer Relationship Model (“CRM”) data and/or metadata, etc.), tables (e.g., custom object table, unified index tables, description tables, etc.), computing devices (e.g., server computers, desktop computers, mobile computers, such as tablet computers, smartphones, etc.), software development languages, applications, and/or development tools or kits (e.g., Force.com®, Force.com, Salesforce1®, Apex™ code, JavaScript™, jQuery™, Developerforce™, Visualforce™, Service Cloud Console Integration Toolkit™ (“Integration Toolkit” or “Toolkit”), Platform on a Service™ (“PaaS”), Chatter® Groups, Sprint Planner®, MS Project®, etc.), domains (e.g., Google®, Facebook®, LinkedIn®, Skype®, etc.), etc., discussed in this document are merely used as examples for brevity, clarity, and ease of understanding and that embodiments are not limited to any particular number or type of data, metadata, tables, computing devices, techniques, programming languages, software applications, software development tools/kits, etc.

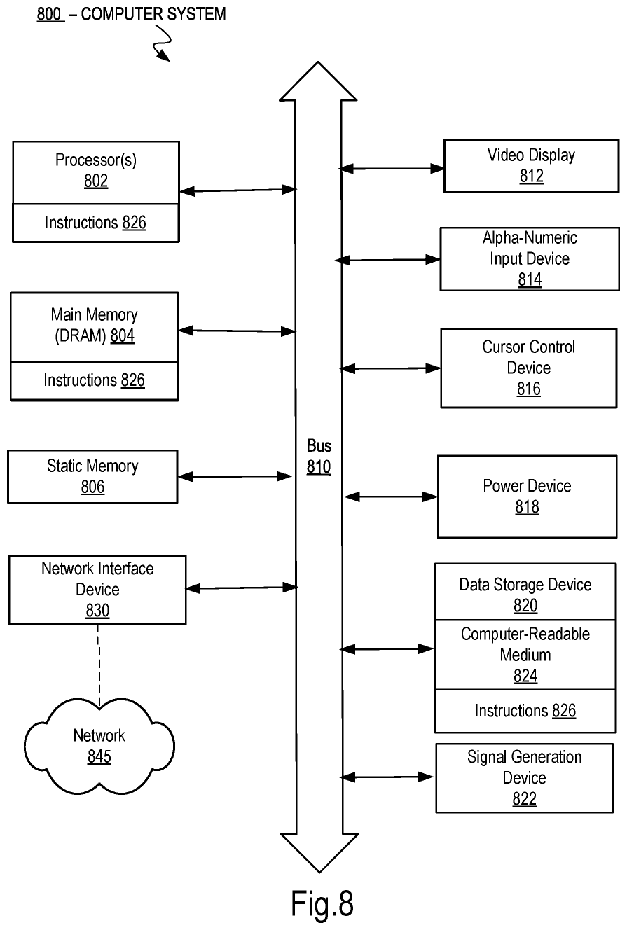

FIG. 8 illustrates a diagrammatic representation of a machine in the exemplary form of a computer system 800 within which a set of instructions (e.g., for causing the machine to perform any one or more of the methodologies discussed herein) may be executed. In alternative implementations, the machine may be connected (e.g., networked) to other machines in a LAN, a WAN, an intranet, an extranet, or the Internet. The machine may operate in the capacity of a server or a client machine in client-server network environment, or as a peer machine in a peer-to-peer (or distributed) network environment. The machine may be a personal computer (PC), a tablet PC, a set-top box (STB), a PDA, a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Some or all of the components of the computer system 800 may be utilized by or illustrative of any of the electronic components described herein (e.g., any of the components illustrated in or described with respect to FIGS. 1, 2 and 7A-7B).

The exemplary computer system 800 includes a processing device (processor) 802, a main memory 804 (e.g., ROM, flash memory, dynamic random access memory (DRAM) such as synchronous DRAM (SDRAM) or Rambus DRAM (RDRAM), etc.), a static memory 806 (e.g., flash memory, static random access memory (SRAM), etc.), and a data storage device 820, which communicate with each other via a bus 810.

Processor 802 represents one or more general-purpose processing devices such as a microprocessor, central processing unit, or the like. More particularly, processor 802 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. Processor 802 may also be one or more special-purpose processing devices such as an application specific integrated circuit (ASIC), a field programmable gate array (FPGA), a digital signal processor (DSP), network processor, or the like. Processor 802 is configured to execute instructions 826 for performing the operations and steps discussed herein. Processor 802 may have one or more processing cores.

Computer system 800 may further include a network interface device 830. Computer system 800 also may include a video display unit 812 (e.g., a liquid crystal display (LCD), a cathode ray tube (CRT), or a touch screen), an alphanumeric input device 814 (e.g., a keyboard), a cursor control device 816 (e.g., a mouse or touch screen), and a signal generation device 822 (e.g., a loud speaker).

Power device 818 may monitor a power level of a battery used to power computer system 800 or one or more of its components. Power device 818 may provide one or more interfaces to provide an indication of a power level, a time window remaining prior to shutdown of computer system 800 or one or more of its components, a power consumption rate, an indicator of whether computer system is utilizing an external power source or battery power, and other power related information. In some implementations, indications related to power device 818 may be accessible remotely (e.g., accessible to a remote back-up management module via a network connection). In some implementations, a battery utilized by power device 818 may be an uninterruptable power supply (UPS) local to or remote from computer system 800. In such implementations, power device 818 may provide information about a power level of the UPS.

Data storage device 820 may include a computer-readable storage medium 824 (e.g., a non-transitory computer-readable storage medium) on which is stored one or more sets of instructions 826 (e.g., software) embodying any one or more of the methodologies or functions described herein. Instructions 826 may also reside, completely or at least partially, within main memory 804 and/or within processor 802 during execution thereof by computer system 800, main memory 804, and processor 802 also constituting computer-readable storage media. Instructions 826 may further be transmitted or received over a network 845 via network interface device 830.

In one implementation, instructions 826 include instructions for performing any of the implementations described herein. While computer-readable storage medium 824 is shown in an exemplary implementation to be a single medium, it is to be understood that computer-readable storage medium 824 may include a single medium or multiple media (e.g., a centralized or distributed database, and/or associated caches and servers) that store the one or more sets of instructions.

While the subject matter disclosed herein has been described by way of example and in terms of the specific embodiments, it is to be understood that the claimed embodiments are not limited to the explicitly enumerated embodiments disclosed. To the contrary, the disclosure is intended to cover various modifications and similar arrangements as are apparent to those skilled in the art. Therefore, the scope of the appended claims is to be accorded the broadest interpretation so as to encompass all such modifications and similar arrangements. It is to be understood that the above description is intended to be illustrative, and not restrictive. Many other embodiments will be apparent to those of skill in the art upon reading and understanding the above description. The scope of the disclosed subject matter is therefore to be determined in reference to the appended claims, along with the full scope of equivalents to which such claims are entitled.

What is claimed is:

1. A computer-implemented method of backing up a storage cluster comprising:
a processor in communication with a cluster of storage nodes, the processor performing logic for:
storing an identifier of the cluster of storage nodes;
collecting one or more node health statuses for the cluster, a node health status indicating whether a storage node in the cluster is any of a healthy node capable of executing a backup job and an unhealthy node incapable of executing the backup job;
determining healthy nodes based on node health statuses collected for the cluster;
scheduling the backup job for the cluster; and
executing the backup job for the cluster based on the healthy nodes, including executing backup operations on the healthy nodes and excluding unhealthy nodes.

2. The computer-implemented method of claim 1, wherein the identifier of the cluster of storage nodes is based on a network identifier defined for the cluster in a network of storage nodes organized into clusters.

3. The computer-implemented method of claim 1, wherein the storage node comprises one or more database servers.

4. The computer-implemented method of claim 1, the processor further performing logic for:
evaluating the node health status based on a current operation status of the storage node in the cluster, the current operation status including any of how recently the storage node executed a backup operation, whether a storage node network file system (NFS) mount status is valid and whether the storage node has a valid credential for the executing the backup job for the cluster.

5. The computer-implemented method of claim 1, wherein the identifier of the cluster is stored in a cluster database for managing storage clusters.

6. The computer-implemented method of claim 5, wherein the one or more node health statuses collected for the cluster is stored in any of a node health database and a node health table of the cluster database.

7. The computer-implemented method of claim 5, wherein the backup job for the cluster is stored in a job management database for queuing backup jobs awaiting execution.

8. The computer-implemented method of claim 7, where scheduling the backup job includes generating a backup action request for the identifier of the cluster in a job management table of the job management database.

9. The computer-implemented method of claim 8, the processor further performing logic for:
polling the job management database for the backup job, including polling the job management database for new backup action requests.

10. The computer-implemented method of claim 7, further comprising an application server to manage the storage cluster in communication with any of the processor, cluster database, node health database and job management database, including backing up the storage cluster.

11. A system to back up storage clusters of a computing platform comprising:
a storage cluster having multiple nodes hosted in a computing platform;
at least one processor capable of executing instructions in the computing platform to cause the at least one processor to:
track the storage cluster by a network identifier in a network connecting the multiple nodes;
sample one or more node health statuses for the storage cluster, a node health status indicating whether a node in the storage cluster is any one of a healthy node eligible to execute a backup job and an unhealthy node not eligible to execute the backup job;
determine one or more healthy nodes based on node health statuses collected for the storage cluster;
schedule the backup job for the storage cluster; and
execute the backup job for the storage cluster based on the one or more healthy nodes, including to execute the backup job on the healthy nodes and exclude unhealthy nodes.

12. The system of claim 11, wherein the node in the storage cluster comprises one or more database servers.

13. The system of claim 11, the at least one processor further to:
evaluate the node health status based on a current operation status of the node in the storage cluster, including any of how recently the node executed a backup operation, whether a node network file system (NFS) mount status is valid, and whether the node has a valid credential for the executing the backup job for the storage cluster.

14. The system of claim 11, wherein the network identifier to track the storage cluster is maintained in a backup management repository for managing storage clusters along with the one or more node health statuses sampled for the storage cluster, the backup management repository including any of a database and table data structures.

15. The system of claim 14, wherein the backup job for the cluster is stored in the backup management repository including in a job management database for queuing backup jobs awaiting execution.

16. The system of claim 15, wherein the backup job includes a backup action request scheduled using the network identifier of the storage cluster, the backup action request queued in a job management table of the job management database.

17. The system of claim 16, the at least one processor further to:
poll the job management database for the backup job, including to poll the job management database for new backup action requests.

18. The system of claim 17, further comprising:
an application server to manage storage clusters in communication with any of the at least one processor and the backup management repository, the application server to cause the backup job to be executed on one or more healthy nodes of the storage cluster based on the one or more node health statuses sampled for the storage cluster.

19. At least one tangible, non-transitory computer-readable storage medium having instructions encoded thereon which, when executed by a processing device in a database storage system, cause the processing device to:
store an identifier of a cluster of storage nodes of the database storage system;
sample one or more node health statuses for the cluster, a node health status indicating whether a storage node in the cluster is any of a healthy node capable of executing a backup job and an unhealthy node not capable of executing the backup job;
determine healthy nodes based on node health statuses collected for the cluster;
schedule the backup job for the cluster; and
execute the backup job for the cluster based on the healthy nodes, including to execute backup operations on the healthy nodes and to exclude the unhealthy nodes.

20. The at least one tangible, non-transitory computer-readable storage medium of claim 19, the processing device further to:
evaluate the node health status based on a current operation status of the storage node in the cluster, the current operation status including any of how recently the storage node executed a backup operation, whether a storage node network file system (NFS) mount status is valid and whether the storage node has a valid credential for the executing the backup job for the cluster.
